(19) United States
(12) Patent Application Publication
(10) Pub. No.: US 2024/0103544 A1
(43) Pub. Date: Mar. 28, 2024

(54) CONVEYANCE SYSTEM, CONTROL APPARATUS, AND CONTROL METHOD

(71) Applicant: NEC Corporation, Minato-ku, Tokyo (JP)

(72) Inventors: Taichi Kumagai, Tokyo (JP); Shinya Yasuda, Tokyo (JP)

(73) Assignee: NEC Corporation, Minato-ku, Tokyo (JP)

(21) Appl. No.: 18/275,140

(22) PCT Filed: Feb. 5, 2021
(86) PCT No.: PCT/JP2021/004228

§ 371 Date: Jul. 31, 2023

(51) Int. Cl. G05D 1/646; G05D 1/249; G05D 1/69; G08G 1/00

(52) U.S. Cl. CPC G05D 1/646; G05D 1/249; G05D 1/69; G08G 1/20; G05D 2109/10

(57) ABSTRACT

A conveyance system (1) according to the present disclosure includes: a conveyance vehicle (10) that conveys an object based on a first traveling path; a sensor (20) that transmits information regarding a position of the conveyance vehicle (10) via a network; a communication unit (32) that can communicate with the conveyance vehicle (10) and the sensor (20); and a control unit (31) that controls the conveyance vehicle (10) via the communication unit (32). The control unit (31) determines a second traveling path based on the information regarding the position of the conveyance vehicle (10) and corrects a traveling trajectory of the conveyance vehicle (10) based on the first traveling path and the second traveling path.

### TECHNICAL FIELD

The present disclosure relates to a conveyance system, a control apparatus, and a control method.

### BACKGROUND ART

In a factory or the like, conveyance vehicles have been used to move objects such as mechanical parts or materials. One example of a traveling system of a conveyance vehicle is a traveling system that guides a conveyance vehicle by guiding signs such as magnetic tapes.

Patent Literature 1 discloses a technique for allowing an automated conveyance vehicle to travel along a predetermined traveling path as the automated conveyance vehicle is guided by guiding signs laid in a traveling path, and correcting the traveling of the automated conveyance vehicle when it is detected that the position of the automated conveyance vehicle has deviated from the predetermined traveling path.

### CITATION LIST

### Patent Literature

[Patent Literature 1] Japanese Unexamined Patent Application Publication No. 2016-224903

### SUMMARY OF INVENTION

### Technical Problem

However, when a conveyance vehicle travels along a predetermined traveling path in accordance with guiding signs laid in a traveling path, like in the technique disclosed in Patent Literature 1, it is impossible to generate a traveling path with a high degree of freedom. For example, when there is a change in the traveling path along which a conveyance vehicle can travel due to a change in the position of a material in the factory, guiding signs need to be laid again.

Another example of the traveling system of the conveyance vehicle includes a traveling system by which a conveyance vehicle travels without guiding signs being used. With this traveling system, it becomes possible to generate a path with a high degree of freedom. In this traveling system, however, since there are no guiding signs, traveling of a conveyance vehicle is likely to be affected by wheel wear, floor smoothness, the mass of an object, etc. Therefore, when a conveyance vehicle travels, for example, in a curved section, the conveyance vehicle may travel along a path that deviates from the traveling path.

The present disclosure has been made to solve the aforementioned problem, and an object of the present disclosure is to provide a conveyance system, a control apparatus, and a control method capable of correcting a traveling trajectory of a conveyance vehicle deviated from a traveling path.

### Solution to Problem

A conveyance system according to one aspect includes: a conveyance vehicle configured to convey an object based on a first traveling path; a sensor configured to transmit information regarding a position of the conveyance vehicle via a network; a communication unit configured to be able to communicate with the conveyance vehicle and the sensor; and a control unit configured to control the conveyance vehicle via the communication unit, in which the control unit determines a second traveling path based on the information regarding the position of the conveyance vehicle, and the control unit corrects a traveling trajectory of the conveyance vehicle based on the first traveling path and the second traveling path.

A control apparatus according to one aspect includes: a communication unit configured to be able to communicate with a conveyance vehicle that conveys an object based on a first traveling path; and a control unit configured to control the conveyance vehicle via the communication unit, in which the communication unit receives information regarding the position of the conveyance vehicle from a sensor via a network, the control unit determines a second traveling path based on the information regarding the position of the conveyance vehicle, and the control unit corrects a traveling trajectory of the conveyance vehicle based on the first traveling path and the second traveling path.

A control method according to one aspect is a control method executed by a control apparatus, the control method including: a receiving step of receiving, from a sensor, information regarding a position of a conveyance vehicle that conveys an object based on a first traveling path via a network; and a control step of determining a second traveling path based on the information regarding the position of the conveyance vehicle, and correcting a traveling trajectory of the conveyance vehicle based on the first traveling path and the second traveling path.

### Advantageous Effects of Invention

According to the aforementioned aspects, it is possible to obtain an effect that it is possible to provide a conveyance system, a control apparatus, and a control method capable of correcting a traveling trajectory of a conveyance vehicle deviated from a traveling path.

### BRIEF DESCRIPTION OF DRAWINGS

FIG. 1 is a diagram showing a configuration example of a conveyance system according to a first example embodiment;

FIG. 2 is a diagram showing an example of information regarding a position of a conveyance vehicle;

FIG. 3 is a diagram showing a configuration example of a control apparatus according to the first example embodiment;

FIG. 4 is a flowchart showing an example of a flow of a schematic operation of the conveyance system according to the first example embodiment;

FIG. 5 is a diagram showing a configuration example of a conveyance system according to a second example embodiment;

FIG. 6 is a diagram showing an example of a third traveling path along which a conveyance vehicle will travel, the third traveling path being predicted by a prediction unit according to the second example embodiment;

FIG. 7 is a diagram showing an example of the third traveling path along which the conveyance vehicle will travel, the third traveling path being predicted by the prediction unit according to the second example embodiment;

FIG. 8 is a flowchart showing an example of a flow of a schematic operation of the conveyance system according to the second example embodiment;

FIG. 9 is a diagram showing a configuration example of a conveyance system according to a third example embodiment; and

FIG. 10 is a block diagram showing an example of a hardware configuration of a computer that implements the control apparatus according to the first example embodiment.

### EXAMPLE EMBODIMENT

Hereinafter, with reference to the drawings, example embodiments of the present disclosure will be described. For the sake of clarification of the description, the following descriptions and the drawings are omitted and simplified as appropriate. Further, throughout the drawings, the same components are denoted by the same reference symbols and redundant descriptions are omitted as necessary.

### First Example Embodiment

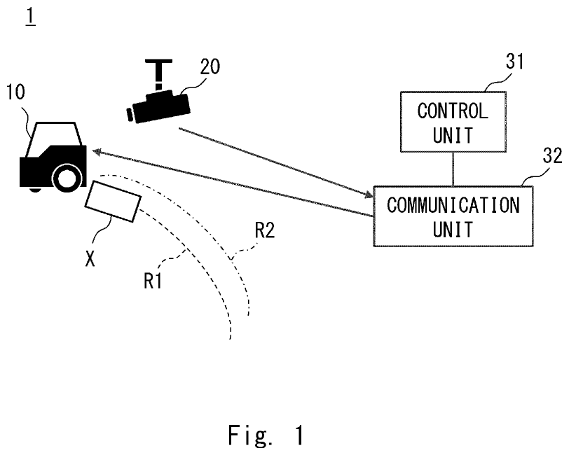

Referring first to FIG. 1, a configuration example of a conveyance system 1 according to a first example embodiment will be described. As shown in FIG. 1, the conveyance system 1 according to the first example embodiment includes a conveyance vehicle 10, a sensor 20, a control unit 31, and a communication unit 32.

The conveyance vehicle 10 conveys an object X. It is assumed that a traveling system of the conveyance vehicle 10 is a traveling system in which the conveyance vehicle 10 is made to travel without using guiding signs. For example, the conveyance vehicle 10 is used to convey an object X such as a mechanical part or a material in a factory or the like.

Further, the conveyance system of the conveyance vehicle 10 may be any conveyance system. For example, the conveyance vehicle 10 may be, for example, a conveyance vehicle which an object X is placed thereon, a conveyance vehicle which pulls a movable base equipped with a traction equipment, the object X being placed on the movable base, a conveyance vehicle that fixes the object X in the front of the conveyance vehicle 10 and pushes this object X, or a conveyance vehicle that lifts the entire movable base which the object X is placed thereon.

Further, while it is assumed in FIG. 1 that the number of conveyance vehicles 10 is one, the object X may be carried by two or more conveyance vehicles 10. Note that an example in which an object X is conveyed by two conveyance vehicles 10 will be described in a third example embodiment that will be described later.

The sensor 20 transmits information regarding the position of the conveyance vehicle 10 to the control unit 31 via a network that is not shown. For example, the sensor 20 may be, for example, a camera (a depth camera, a stereo camera, and a Time of Flight (ToF) camera), a laser sensor (2D-Light Detection and Ranging (LiDAR), 3D-LiDAR, etc.), or a radar sensor.

Further, the sensor 20 may transmit information regarding the position of the conveyance vehicle 10 regularly or may transmit information regarding the position of the conveyance vehicle 10 when the sensor 20 has received a transmission request from the control unit 31 via the communication unit 32.

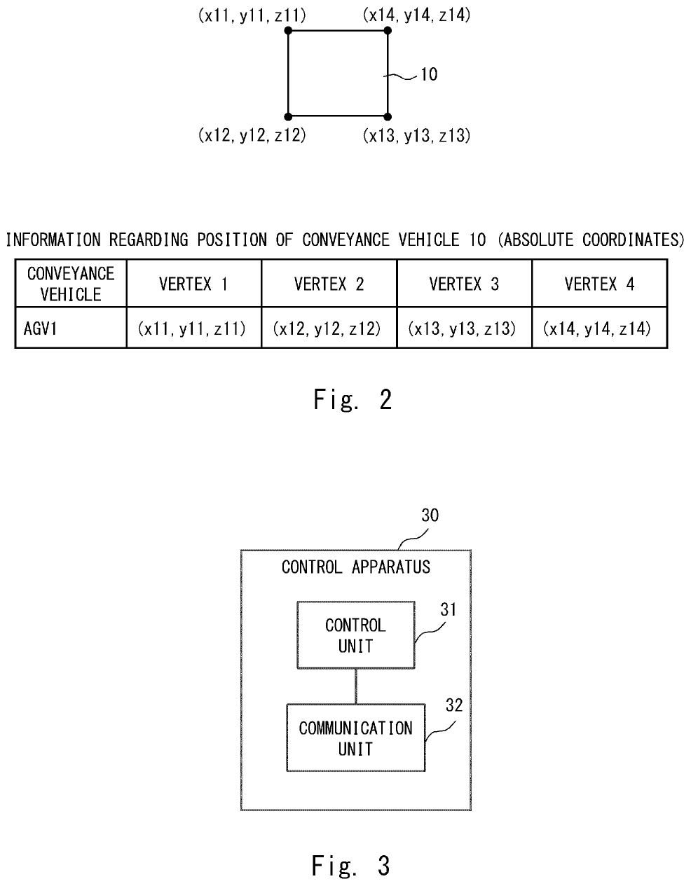

Further, the information regarding the position of the conveyance vehicle 10 transmitted by the sensor 20 may be, for example, an image of the conveyance vehicle 10 and its surroundings, absolute coordinates of the conveyance vehicle 10, or relative coordinates of the conveyance vehicle 10 with respect to a predetermined position (e.g., a target position). FIG. 2 shows an example in which the information regarding the position of the conveyance vehicle 10 is absolute coordinates of the conveyance vehicle 10. FIG. 2 shows an example of absolute coordinates of the conveyance vehicle 10 having four vertices 1 to 4 in a plan view. In the example shown in FIG. 2, the information regarding the position of the conveyance vehicle 10 indicates absolute coordinates of each of the four vertices 1-4 that the conveyance vehicle 10 has.

The aforementioned network is a communication network in which two or more devices are connected via a line or wirelessly. The wireless communication network may include, for example, a network of 4G (Generation), local 5G, Wireless Fidelity (Wi-Fi), or Long Term Evolution (LTE).

The communication unit 32 can communicate with the conveyance vehicle and the sensor 20. The communication unit 32 may communicate with the sensor 20 via the aforementioned network. Further, when the aforementioned network is a wireless communication network, the communication unit 32 may communicate with the conveyance vehicle 10 via the aforementioned network. Further, when the aforementioned network is a wired communication network, the communication unit 32 may communicate with the conveyance vehicle 10 via a network, which is a wireless communication network other than the aforementioned network.

The control unit 31 controls the conveyance vehicle 10 via the communication unit 32. At this time, the control unit 31 transmits at least one of control information as shown in the following (1) to (3) to the conveyance vehicle 10 via the communication unit 32.
(1) the rotation speed [m/s] of the right and left wheels
(2) path information and positional information

The path information may be, for example, coordinate information of a target point sequence ((x1,y1,z1)→(x2,y2,z2)→(x3,y3,z3)). In the case of (2), the rotation speed of the right and left wheels is calculated by the conveyance vehicle 10. Further, in the case of (2), the conveyance vehicle 10 may travel by associating the coordinate information of the target point sequence with a map of a facility such as a factory where the conveyance vehicle 10 travels (a map showing positions of walls, aisles, or other obstacles).
(3) Information for driving wheels

The information for driving wheels may be information instructing, for example, the conveyance vehicle 10 to move a distance b [cm] at a speed a [cm/s] and then move while the angle of the wheels is set to c[rad].

Here, the control unit 31 controls the conveyance vehicle 10 in such a way that the conveyance vehicle 10 travels along a first traveling path R1. The first traveling path R1 is, for example, a traveling path generated to enable the conveyance vehicle 10 to convey the object X to the target position, or a traveling path generated to return the conveyance vehicle 10 to a standby position. Note that the first traveling path R1 may be generated by the control unit 31 based on the map of the facility where the conveyance vehicle 10 travels, the target position, the departure position or the like, or may be generated by a user and input to the control unit 31.

As described above, the conveyance vehicle 10 conveys the object X based on the first traveling path R1. However, the traveling system of the conveyance vehicle 10 is a traveling system that does not use guiding signs. Therefore, the traveling of the conveyance vehicle 10 tends to be affected by wheel wear, floor smoothness, the mass of the object X, etc. As a result, when, for example, the first traveling path R1 includes a curved section, as shown in FIG. 1, and the conveyance vehicle 10 travels in this curved section, the conveyance vehicle 10 may travel along a path that deviates from the first traveling path R1. Specifically, in the curved section, the conveyance vehicle 10 may travel along a path that widens/expands beyond the planned path. FIG. 1 shows an example in which the conveyance vehicle 10 travels along a second traveling path R2 which deviates from the first traveling path R1. It can therefore be said that the second traveling path R2 is a traveling path of the conveyance vehicle 10 when the traveling thereof has been influenced by wheel wear or the like, while the first traveling path R1 is a traveling path of the conveyance vehicle 10 when the traveling thereof has not been influenced by wheel wear or friction on the floor.

In the first example embodiment, when the conveyance vehicle 10 deviates from the first traveling path R1, the control unit 31 performs the following operation in order to correct the traveling trajectory of the conveyance vehicle 10.

That is, the control unit 31 determines the second traveling path R2 based on the information regarding the position of the conveyance vehicle 10, the information being received by the communication unit 32 from the sensor 20.

Then, the control unit 31 corrects the traveling trajectory of the conveyance vehicle 10 based on the first traveling path R1 and the second traveling path R2. Specifically, the control unit 31 corrects the traveling trajectory of the conveyance vehicle 10 in such a way that the conveyance vehicle travels along the first traveling path R1 or travels on the first traveling path R1. At this time, the control unit 31 may correct the traveling trajectory of the conveyance vehicle 10 by transmitting at least one of the control information items shown in the above (1) to (3) to the conveyance vehicle 10. Further, the control unit 31 may transmit, in a case where the control unit 31 corrects a traveling trajectory when the conveyance vehicle 10 is traveling in a curved section, control information indicating the difference between the rotation speed of the right wheel and the rotation speed of the left wheel to the conveyance vehicle 10.

The control unit 31 may correct the traveling trajectory of the conveyance vehicle 10 when the control unit 31 has determined that an amount of deviation of the conveyance vehicle 10 from the first traveling path R1 has become equal to or larger than a predetermined value. For example, when the position of the conveyance vehicle 10 has deviated from the first traveling path R1 by a predetermined distance or more or when the difference from the angular velocity of the conveyance vehicle 10 in a case where the conveyance vehicle 10 travels along the first traveling path R1 has become equal to or larger than a predetermined value, it may be determined that the amount of deviation has become equal to or larger than the predetermined value. Alternatively, the correction of the traveling trajectory of the conveyance vehicle 10 by the control unit 31 may be executed when it is determined by the control unit 31 that the conveyance vehicle 10 is traveling in a specific section or has approached the specific section. The specific section is a curved section or the like included in the first traveling path R1.

Note that the control unit 31 and the communication unit 32 may be provided independently from each other, and may be provided, for example, on a cloud. However, this is merely an example, and the control unit 31 and the communication unit 32 may be provided in one apparatus (control apparatus 30), as shown in FIG. 3.

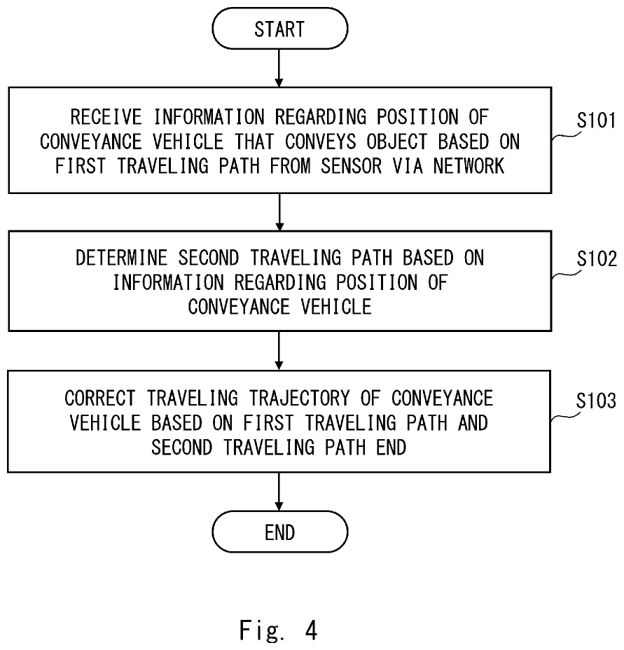

Referring next to FIG. 4, an example of a flow of a schematic operation of the conveyance system 1 according to the first example embodiment will be described.

As shown in FIG. 4, first, the communication unit 32 receives the information regarding the position of the conveyance vehicle 10 that conveys the object X based on the first traveling path R1 from the sensor 20 via a network (Step S101).

Next, the control unit 31 determines the second traveling path R2 based on the information regarding the position of the conveyance vehicle 10 (Step S102).

After that, the control unit 31 corrects the traveling trajectory of the conveyance vehicle 10 based on the first traveling path R1 and the second traveling path R2 (Step S103).

As described above, according to the first example embodiment, the communication unit 32 receives the information regarding the position of the conveyance vehicle 10 that conveys the object X based on the first traveling path R1 from the sensor 20 via a network. The control unit 31 determines the second traveling path R2 based on the information regarding the position of the conveyance vehicle 10 and corrects the traveling trajectory of the conveyance vehicle 10 based on the first traveling path R1 and the second traveling path R2.

Therefore, even in a case where the conveyance vehicle 10 is traveling while deviating from the first traveling path R1 due to the influence of wheel wear, floor smoothness, the mass of the object X or the like, it is possible to correct the traveling trajectory of the conveyance vehicle 10.

### Second Example Embodiment

A second example embodiment is an example in which the configuration and the operation of the control unit 31 according to the above-described first example embodiment are made more specific.

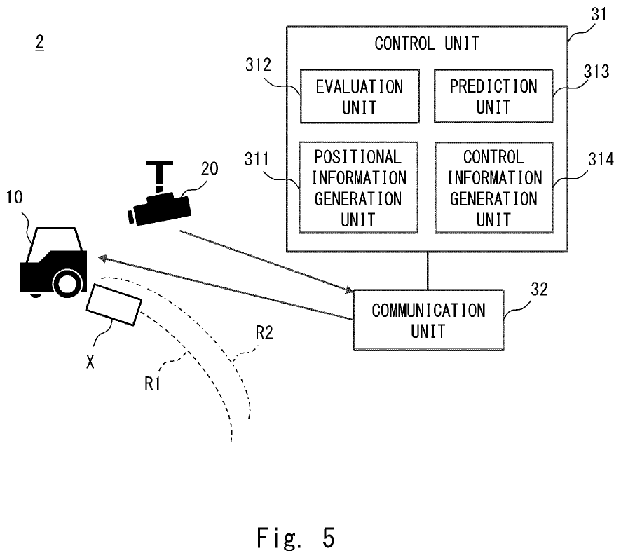

Referring first to FIG. 5, a configuration example of a conveyance system 2 according to the second example embodiment will be described. As shown in FIG. 5, while the overall configuration of the conveyance system 2 according to the second example embodiment is similar to that of the conveyance system 1 according to the first example embodiment described above, the configuration of the control unit 31 of the conveyance system 2 according to the second example embodiment is different from that of the conveyance system 1 according to the first example embodiment. That is, the control unit 31 according to the second example embodiment includes a positional information generation unit 311, an evaluation unit 312, a prediction unit 313, and a control information generation unit 314. Note that the positional information generation unit 311, the evaluation unit 312, the prediction unit 313, and the control information generation unit 314 are connected to one another by a bus or the like (not shown).

The positional information generation unit 311 generates, based on the information regarding the position of the conveyance vehicle 10 (e.g., an image of the conveyance vehicle 10 and its surroundings) received from the sensor 20 by the communication unit 32, positional information indicating the position of the conveyance vehicle 10 (e.g., absolute coordinates of the conveyance vehicle 10, or relative coordinates of the conveyance vehicle 10 with respect to a predetermined position), and outputs the generated positional information to the evaluation unit 312.

The evaluation unit 312 evaluates, based on the information on the position of the conveyance vehicle 10 generated by the positional information generation unit 311, whether or not an amount of deviation of the conveyance vehicle 10 from the first traveling path R1 has become equal to or larger than a predetermined value. When, for example, the position of the conveyance vehicle 10 has deviated from the first traveling path R1 by a predetermined distance or more or when the difference from the angular velocity of the conveyance vehicle 10 in a case where the conveyance vehicle 10 travels along the first traveling path R1 has become equal to or larger than a predetermined value, it may be determined that the amount of deviation has become equal to or larger than the predetermined value. When it is determined that the amount of deviation of the conveyance vehicle 10 from the first traveling path R1 has become equal to or larger than the predetermined value, the evaluation unit 312 determines the second traveling path R2 based on the information on the position of the conveyance vehicle 10 generated by the positional information generation unit 311. Then the evaluation unit 312 compares the first traveling path R1 with the second traveling path R2, generates evaluation information indicating the result of the comparison, and outputs the generated evaluation information to the prediction unit 313. The evaluation information is, for example, the difference in the amount of deviation between the position of the conveyance vehicle 10 in a case where the conveyance vehicle 10 travels along the first traveling path R1 and the position of the conveyance vehicle 10 in a case where the conveyance vehicle 10 travels along the second traveling path R2, or the difference between the angular velocity of the conveyance vehicle 10 in a case where the conveyance vehicle 10 travels along the first traveling path R1 and the angular velocity of the conveyance vehicle 10 in a case where the conveyance vehicle 10 travels along the second traveling path R2.

Alternatively, the evaluation unit 312 determines, based on the information on the position of the conveyance vehicle 10 generated by the positional information generation unit 311, whether the conveyance vehicle 10 is traveling in a specific section (e.g., a curved section included in the first traveling path R1) or has approached the specific section. When the conveyance vehicle 10 is traveling in the specific section or has approached the specific section, the evaluation unit 312 determines the second traveling path R2 based on the information on the position of the conveyance vehicle 10 generated by the positional information generation unit 311. Then, the evaluation unit 312 compares the first traveling path R1 with the second traveling path R2, generates evaluation information indicating the result of the comparison, and outputs the generated evaluation information to the prediction unit 313.

While it is assumed that the first traveling path R1 is held by the positional information generation unit 311, the first traveling path R1 may be held by a traveling path management unit (not shown). Further, the first traveling path R1 may be generated by the positional information generation unit 311 based on a map of a facility such as a factory where the conveyance vehicle 10 travels (a map showing positions of walls, aisles, or other obstacles), the target position, the departure position or the like, may be generated by a path generation unit (not shown), or may be generated by a user and then input to the positional information generation unit 311. Further, the path generation unit may be provided inside the control unit 31 or may be provided outside of the control unit 31. Further, while it is assumed that the map of the facility is held by the positional information generation unit 311, the map may be held by a map management unit (not shown).

The prediction unit 313 predicts, based on time-series data of the evaluation information generated by the evaluation unit 312, a third traveling path R3 along which the conveyance vehicle 10 is going to travel, generates prediction information including the predicted third traveling path R3, and outputs the generated prediction information to the control information generation unit 314. That is, the prediction unit 313 predicts a path when the conveyance vehicle 10 keeps traveling (the third traveling path R3) in accordance with first control information that will be described later. For example, the prediction unit 313 predicts the third traveling path R3 by performing regression analysis on time-series data of the evaluation information.

In this case, the prediction unit 313 predicts the third traveling path R3 when an amount of deviation of the conveyance vehicle 10 from the first traveling path R1 has become equal to or larger than a predetermined value or when the conveyance vehicle 10 is traveling in a specific section or has approached the specific section.

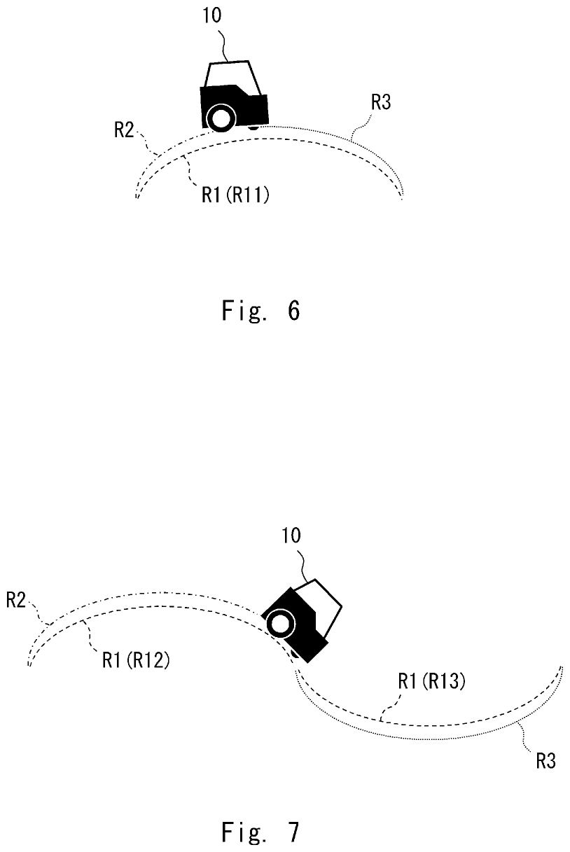

Referring now to FIGS. 6 and 7, an example in which the prediction unit 313 predicts a third traveling path R3 when the conveyance vehicle 10 is traveling in a specific section or has approached the specific section will be described.

In the example shown in FIG. 6, in a case where the conveyance vehicle 10 is traveling in a specific section R11 (in FIG. 6, a curved section) included in the first traveling path R1, the prediction unit 313 predicts a third traveling path R3 along which the conveyance vehicle 10 is going to travel in the specific section R11 based on the evaluation information of the specific section R11.

In the example shown in FIG. 7, in a case where the conveyance vehicle 10 is traveling in a specific section R12 (in FIG. 7, a curved section) included in the first traveling path R1 and has approached another specific section R13 (in FIG. 7, a curved section) included in the first traveling path R1, the prediction unit 313 predicts a third traveling path R3 along which the conveyance vehicle 10 is going to travel in the specific section R13 based on the evaluation information of the specific section R12.

The control information generation unit 314 generates control information for causing the conveyance vehicle 10 to travel along the intended traveling path and transmits the generated control information to the conveyance vehicle 10 via the communication unit 32.

Here, when the conveyance vehicle 10 is made to travel along the first traveling path R1, the control information generation unit 314 generates control information (hereinafter this information will be referred to as first control information as appropriate) based on the first traveling path R1.

Further, when the traveling trajectory of the conveyance vehicle 10 is corrected for the first traveling path R1, the control information generation unit 314 generates control information (hereinafter this information will be referred to as second control information as appropriate) based on the first traveling path R1, and the third traveling path R3 included in the prediction information generated by the prediction unit 313. When, for example, the curve radius of the third traveling path R3 is larger than the curve radius of the first traveling path R1 in a curve section, control information for increasing the difference between the rotation speed of the right wheel and the rotation speed of the left wheel is generated in such a way that the conveyance vehicle 10 makes smaller curves.

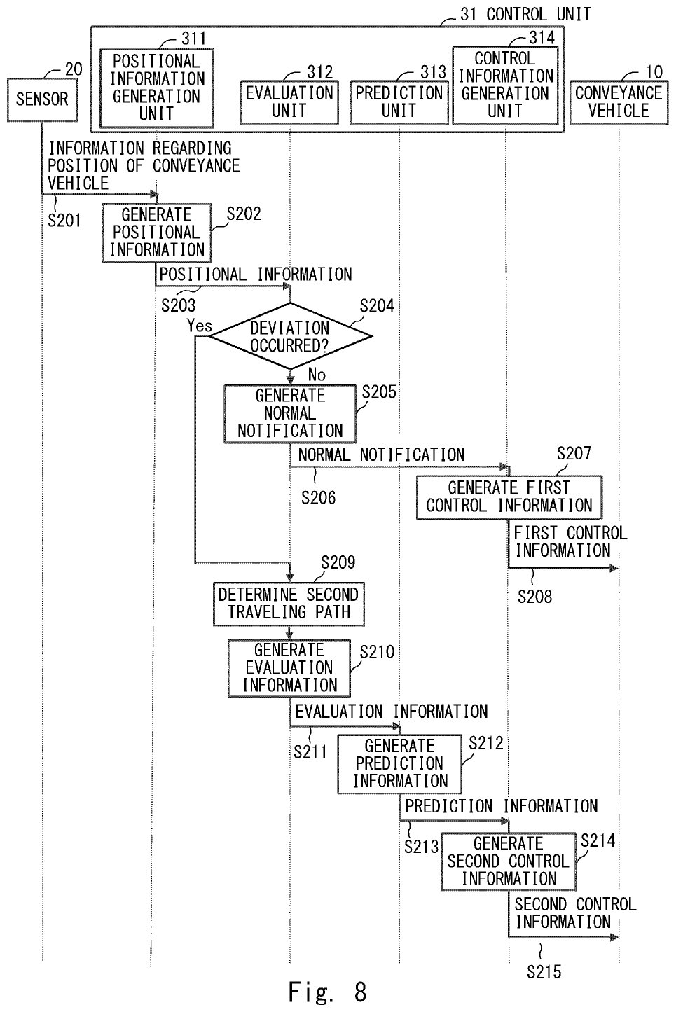

Referring next to FIG. 8, an example of a flow of a schematic operation of the conveyance system 2 according to the first example embodiment will be described. Note that FIG. 8 shows an example in which the traveling trajectory of the conveyance vehicle 10 is corrected when the position of the conveyance vehicle 10 has deviated from the first traveling path R1 by a predetermined distance or more. Further, the communication unit 32 is not shown in FIG. 8.

As shown in FIG. 8, the sensor 20 transmits information regarding the position of the conveyance vehicle 10 that conveys the object X based on the first traveling path R1 to the control unit 31 via a network (not shown) and the communication unit 32 (Step S201). Further, the positional information generation unit 311 generates positional information indicating the position of the conveyance vehicle 10 based on the information regarding the position of the conveyance vehicle 10 (Step S202), and outputs the generated positional information to the evaluation unit 312 (Step S203). Hereinafter, it is assumed that Steps S201-S203 are performed repeatedly at predetermined intervals.

Next, the evaluation unit 312 evaluates whether or not the position of the conveyance vehicle 10 deviates from the first traveling path R1 by a predetermined distance or more based on the information on the position of the conveyance vehicle 10 (Step S204).

When the position of the conveyance vehicle 10 does not deviate from the first traveling path R1 by a predetermined distance or more in Step S204 (No in Step S204), the evaluation unit 312 generates a normal notification indicating the result of the evaluation (Step S205) and outputs the generated normal notification to the control information generation unit 314 (Step S206). As long as the normal notification is output from the evaluation unit 312, the control information generation unit 314 generates first control information based on the first traveling path R1 (Step S207), and transmits the generated first control information to the conveyance vehicle 10 via the communication unit 32 (Step S208).

On the other hand, when the position of the conveyance vehicle 10 deviates from the first traveling path R1 by a predetermined distance or more in Step S204 (Yes in Step S204), the evaluation unit 312 determines the second traveling path R2 based on the information on the position of the conveyance vehicle 10 (Step S209). Then, the evaluation unit 312 then compares the first traveling path R1 with the second traveling path R2, generates evaluation information indicating the result of the comparison (Step S210), and outputs the generated evaluation information to the prediction unit 313 (Step S211).

Next, the prediction unit 313 predicts the third traveling path R3 along which the conveyance vehicle 10 is going to travel based on the evaluation information, generates prediction information including the predicted third traveling path R3 (Step S212), and outputs the generated prediction information to the control information generation unit 314 (Step S213).

After that, the control information generation unit 314 generates second control information based on the first traveling path R1 and the third traveling path R3 (Step S214) and transmits the generated second control information to the conveyance vehicle 10 via the communication unit 32 (Step S215).

As described above, according to the second example embodiment, the evaluation unit 312, determines the second traveling path R2 based on the information on the position of the conveyance vehicle 10, and compares the first traveling path R1 with the second traveling path R2.

Therefore, it is possible to determine, when the conveyance vehicle 10 has traveled based on the first traveling path R1, how far the second traveling path R2 deviates from the first traveling path R1.

Further, according to the second example embodiment, the prediction unit 313 predicts, based on the result of comparing the first traveling path R1 with the second traveling path R2, the third traveling path R3 along which the conveyance vehicle 10 is going to travel, and the control information generation unit 314 generates control information (second control information) for correcting the traveling trajectory of the conveyance vehicle 10 based on the first traveling path R1 and the third traveling path R3.

Therefore, it is possible to correct the traveling trajectory in accordance with the future traveling path (the third traveling path R3) of the conveyance vehicle 10 in consideration of the influence of wheel wear, floor smoothness, the mass of the object X, etc.

The other effects of the second example embodiment are similar to those in the above-described first example embodiment.

### Third Example Embodiment

In the above-described first and second example embodiments, it is assumed that one conveyance vehicle 10 conveys an object X. On the other hand, a third example embodiment is an example in which an object X is conveyed by two conveyance vehicles 10.

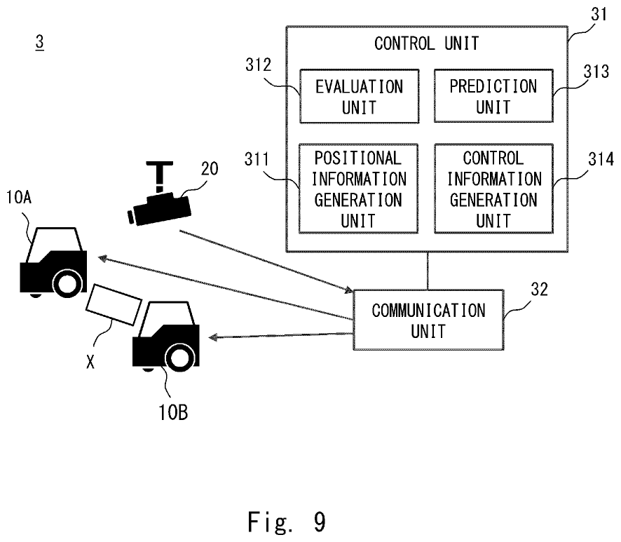

Referring first to FIG. 9, a configuration example of a conveyance system 3 according to the third example embodiment will be described. As shown in FIG. 9, the conveyance system 3 according to the third example embodiment is different from the aforementioned conveyance system 2 according to the second example embodiment in that two conveyance vehicles 10 (a first conveyance vehicle 10A and a second conveyance vehicle 10B) are provided.

The first conveyance vehicle 10A is a leading vehicle.

The second conveyance vehicle 10B, which is a following vehicle, holds the object X between the second conveyance vehicle 10B and the first conveyance vehicle 10A, and the second conveyance vehicle 10B pushes the object X, thereby conveying the object X. Hereinafter, this conveyance is referred to as cooperative conveyance as appropriate.

In the third example embodiment, the control unit 31 generates, for each of the first conveyance vehicle 10A and the second conveyance vehicle 10B, first control information and second control information, and transmits the first control information and the second control information to each of the first conveyance vehicle 10A and the second conveyance vehicle 10B.

Therefore, the sensor 20 transmits information regarding the position of the first conveyance vehicle 10A and information regarding the position of the second conveyance vehicle 10B to the control unit 31 via the communication unit 32.

The positional information generation unit 311 generates positional information indicating the position of the first conveyance vehicle 10A based on the information regarding the position of the first conveyance vehicle 10A and positional information indicating the position of the second conveyance vehicle 10B based on the information regarding the position of the second conveyance vehicle 10B. Then, the positional information generation unit 311 outputs the positional information of the first conveyance vehicle 10A and the positional information of the second conveyance vehicle 10B that have been generated to the evaluation unit 312.

The evaluation unit 312 determines the second traveling path R2 of the first conveyance vehicle 10A based on the positional information of the first conveyance vehicle 10A, compares the first traveling path R1 of the first conveyance vehicle 10A with the second traveling path R2 of the first conveyance vehicle 10A, and generates evaluation information indicating the result of the comparison. At the same time, the evaluation unit 312 determines the second traveling path R2 of the second conveyance vehicle 10B based on the positional information of the second conveyance vehicle 10B, compares the first traveling path R1 of the second conveyance vehicle 10B with the second traveling path R2 of the second conveyance vehicle 10B, and generates evaluation information indicating the result of the comparison. Then, the evaluation unit 312 outputs the evaluation information of the first conveyance vehicle 10A and the evaluation information of the second conveyance vehicle 10B that have been generated to the prediction unit 313.

The prediction unit 313 predicts, based on the evaluation information of the first conveyance vehicle 10A, a third traveling path R3 along which the first conveyance vehicle 10A will travel, and generates prediction information including the predicted third traveling path R3. At the same time, the prediction unit 313 predicts, based on the evaluation information of the second conveyance vehicle 10B, a third traveling path R3 along which the second conveyance vehicle 10B will travel, and generates prediction information including the predicted third traveling path R3. Then, the prediction unit 313 outputs the prediction information of the first conveyance vehicle 10A and the prediction information of the second conveyance vehicle 10B that have been generated to the control information generation unit 314.

In a case where the first conveyance vehicle 10A is made to travel along the first traveling path R1, the control information generation unit 314 generates, based on the first traveling path R1 of the first conveyance vehicle 10A, first control information of the first conveyance vehicle 10A, and transmits the generated first control information of the first conveyance vehicle 10A to the first conveyance vehicle 10A via the communication unit 32.

Further, in a case where the second conveyance vehicle 10B is made to travel along the first traveling path R1, the control information generation unit 314 generates, based on the first traveling path R1 of the second conveyance vehicle 10B, first control information of the second conveyance vehicle 10B, and transmits the generated first control information of the second conveyance vehicle 10B to the second conveyance vehicle 10B via the communication unit 32.

Further, in a case where the traveling trajectory of the first conveyance vehicle 10A is corrected for the first traveling path R1, the control information generation unit 314 generates, based on the first traveling path R1 and the third traveling path R3 of the first conveyance vehicle 10A, second control information of the first conveyance vehicle 10A, and transmits the generated second control information of the first conveyance vehicle 10A to the first conveyance vehicle 10A via the communication unit 32.

Further, in a case where the traveling trajectory of the second conveyance vehicle 10B is corrected for the first traveling path R1, the control information generation unit 314 generates, based on the first traveling path R1 and the third traveling path R3 of the second conveyance vehicle 10B, second control information of the second conveyance vehicle 10B, and transmits the generated second control information of the second conveyance vehicle 10B to the second conveyance vehicle 10B via the communication unit 32.

While the second traveling path R2 of the first conveyance vehicle 10A and the second traveling path R2 of the second conveyance vehicle 10B are both determined in the aforementioned description, the second traveling path R2 of one of the first conveyance vehicle 10A or the second conveyance vehicle 10B may be determined. In this case, the traveling of the first conveyance vehicle 10A and the second conveyance vehicle 10B may be predicted or controlled based on the determined second traveling path R2.

Further, while the positional information of the first conveyance vehicle 10A and the second conveyance vehicle 10B is generated in the aforementioned description, positional information of the object X may be generated instead of the positional information of the first conveyance vehicle 10A and the second conveyance vehicle 10B. In this case, the second traveling path R2 of the first conveyance vehicle 10A and the second traveling path R2 of the second conveyance vehicle 10B may both be determined based on the positional information of the object X, or the second traveling path R2 of one of the first conveyance vehicle 10A or the second conveyance vehicle 10B may be determined based on the positional information of the object X.

However, in a case where the first conveyance vehicle 10A and the second conveyance vehicle 10B convey an object X in cooperation with each other, the second conveyance vehicle 10B, which serves as a following vehicle, pushes the object X, thereby conveying the object X. As a result, the first conveyance vehicle 10A, which serves as a leading vehicle, travels while being pushed by the second conveyance vehicle 10B from behind. Therefore, the first conveyance vehicle 10A tends to deviate from the first traveling path R1 compared to the second conveyance vehicle 10B does.

Therefore, the control unit 31 transmits the first control information and the second control information to the first conveyance vehicle 10A.

In this case, the control unit 31 may continuously transmit the first control information to the second conveyance vehicle 10B and control the second conveyance vehicle 10B with the first control information. Alternatively, the second conveyance vehicle 10B may not travel under the control of the control unit 31. For example, the second conveyance vehicle 10B may include a sensor that detects the first conveyance vehicle 10A and travel following the first conveyance vehicle 10A based on the result of the sensor. Alternatively, the first conveyance vehicle 10A, which serves as a master, may control the second conveyance vehicle 10B, which serves as a slave. Further, in a case where the first conveyance vehicle 10A serves as a master, the first conveyance vehicle 10A may correct the first control information and the second control information of the first conveyance vehicle 10A from the control unit 31 for the second conveyance vehicle 10B, and forward the first control information and the second control information that have been corrected to the second conveyance vehicle 10B.

Note that the control unit 31 is not limited to transmit the first control information and the second control information to the first conveyance vehicle 10A. The control unit 31 may transmit the first control information and the second control information to the second conveyance vehicle 10B. Further, the control unit 31 may transmit the first control information and the second control information to both the first conveyance vehicle 10A and the second conveyance vehicle 10B.

As described above, according to the third example embodiment, the control unit 31 transmits the first control information and the second control information to both the first conveyance vehicle 10A and the second conveyance vehicle 10B or only to the first conveyance vehicle 10A.

Therefore, even in a case where the first conveyance vehicle 10A travels while deviating from the first traveling path R1 since the second conveyance vehicle 10B pushes the first conveyance vehicle 10A from behind, the traveling trajectory of the first conveyance vehicle 10A can be corrected.

While the cooperative conveyance is defined to be conveyance of the object X by holding it by the first conveyance vehicle 10A, which is a leading vehicle, and the second conveyance vehicle 10B, which is a following vehicle, in the third example embodiment, this is merely an example. The cooperative conveyance may be defined to be conveyance of the object X by holding it by right and left conveyance vehicles with respect to the traveling direction.

### Other Example Embodiments

While the sensor 20 detects information regarding the position of the conveyance vehicle 10 when the conveyance vehicle 10 conveys the object X in the aforementioned example embodiments, the sensor 20 may further detect the weight or the size of the object X. Then, a conveyance system according to the present disclosure may further include, as a component, a storage unit (not shown) that stores data when the conveyance vehicle 10 conveys the object X (e.g., object information such as the weight or the size of the object X, a first traveling path R1 along which the object X has been conveyed, or control information). In this case, the control unit 31 may read out, when the conveyance vehicle 10 conveys anther object X1 along the first traveling path R1 next time, data when an object similar to the object X1 is conveyed along a traveling path the same as the first traveling path R1 from the storage unit, and control the conveyance vehicle 10 using the data that has been read out. By using this data, it is possible to know a section in which the traveling trajectory of the conveyance vehicle 10 has been corrected in the past. Therefore, this section may be set as a specific section and the traveling trajectory of the conveyance vehicle 10 may be corrected while the conveyance vehicle 10 is traveling in this specific section or has approached this specific section.

Further, while the control unit 31 serves to generate the information on the position of the conveyance vehicle 10 from the information regarding the position of the conveyance vehicle 10 in the aforementioned example embodiments, the sensor 20 may play this role. In this case, the sensor 20 transmits positional information of the conveyance vehicle 10, not information regarding the position of the conveyance vehicle 10, to the control unit 31.

Further, a gyro sensor that detects an angular velocity may be mounted on the conveyance vehicle 10, and the control unit 31 may generate control information using the angular velocity collected from the conveyance vehicle 10.

Further, the control unit 31 may cause the conveyance vehicle 10 to perform simulation traveling before conveying the object X, preliminarily acquire data for correcting the traveling trajectory, and then actually cause the conveyance vehicle 10 to convey the object X.

### Hardware Configuration of Control Apparatus According to Embodiments

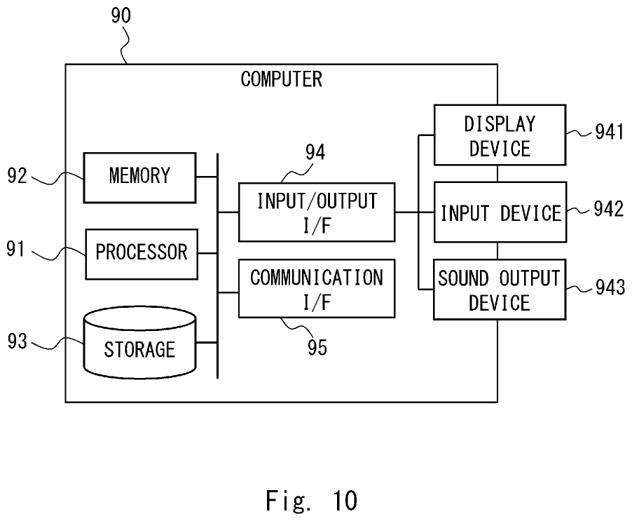

Referring next to FIG. 10, a hardware configuration of a computer 90 that implements the aforementioned control apparatus 30 according to the first example embodiment will be described.

As shown in FIG. 10, the computer 90 includes a processor 91, a memory 92, a storage 93, an input/output interface (input/output I/F) 94, and a communication interface (communication I/F) 95. The processor 91, the memory 92, the storage 93, the input/output interface 94, and the communication interface 95 are connected to one another by a data transmission path for transmitting or receiving data.

The processor 91 is, for example, an arithmetic processing apparatus such as a Central Processing Unit (CPU) or a Graphics Processing Unit (GPU). The memory 92 is, for example, a memory such as a Random Access Memory (RAM) or a Read Only Memory (ROM). The storage 93 is, for example, a storage apparatus such as a Hard Disk Drive (HDD), a Solid State Drive (SSD), or a memory card. Further, the storage 93 may be a memory such as a RAM or a ROM.

The storage 93 stores a program for implementing the functions of the components included in the control apparatus 30. The processor 91 executes each of these programs, thereby implementing each of the functions of the components included in the control apparatus 30. Here, when the processor 91 executes each of the aforementioned programs, the processor 91 may load these programs into the memory 92 and execute the loaded programs, or may execute the program without loading the programs into the memory 92. Further, the memory 92 and the storage 93 may serve to store information or data held by the components included in the control apparatus 30.

The aforementioned programs can be stored and provided to a computer (including the computer 90) using any type of non-transitory computer readable media. Non-transitory computer readable media include any type of tangible storage media. Examples of non-transitory computer readable media include magnetic storage media (such as flexible disks, magnetic tapes, hard disk drives, etc.), optical magnetic storage media (e.g., magneto-optical disks), Compact Disc-ROM (CD-ROM), CD-Recordable (CD-R), CD-ReWritable (CD-R/W), semiconductor memories (such as mask ROM, Programmable ROM (PROM), Erasable PROM (EPROM), flash ROM, RAM, etc.). Further, the program(s) may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

The input/output interface 94 is connected, for example, to a display device 941, an input device 942, and a sound output device 943. The display device 941 is a device such as a Liquid Crystal Display (LCD), a Cathode Ray Tube (CRT) display, or a monitor that displays a screen that corresponds to drawing data processed by the processor 91. The input device 942, which is a device that accepts an operation input by an operator, is, for example, a keyboard, a mouse, and a touch sensor. The display device 941 and the input device 942 may be integrated together, and may be implemented as a touch panel. The sound output device 943 is a device such as a speaker that outputs a sound that corresponds to acoustic data processed by the processor 91.

The communication interface 95 transmits and receives data to and from an external apparatus. For example, the communication interface 95 communicates with an external device via a wired communication path or a wireless communication path.

While the present disclosure has been described above with reference to the example embodiments, the present disclosure is not limited to the aforementioned example embodiments. Various changes that may be understood by one skilled in the art may be made to the configurations and the details of the present disclosure within the scope of the present disclosure.

Further, the whole or part of the example embodiments described above can be described as, but not limited to, the following supplementary notes.

### (Supplementary Note 1)

A conveyance system comprising:

a conveyance vehicle configured to convey an object based on a first traveling path;

a sensor configured to transmit information regarding a position of the conveyance vehicle via a network;

a communication unit configured to be able to communicate with the conveyance vehicle and the sensor; and

a control unit configured to control the conveyance vehicle via the communication unit, wherein

the control unit determines a second traveling path based on the information regarding the position of the conveyance vehicle, and

the control unit corrects a traveling trajectory of the conveyance vehicle based on the first traveling path and the second traveling path.

### (Supplementary Note 2)

The conveyance system according to Supplementary Note 1, wherein

the control unit generates positional information indicating the position of the conveyance vehicle based on the information regarding the position of the conveyance vehicle,

the control unit determines the second traveling path based on the positional information of the conveyance vehicle,

the control unit compares the first traveling path with the second traveling path,

the control unit generates control information for correcting a traveling trajectory of the conveyance vehicle based on the result of comparing the first traveling path with the second traveling path, and

the control unit transmits the control information to the conveyance vehicle via the communication unit.

### (Supplementary Note 3)

The conveyance system according to Supplementary Note 2, wherein

the control unit predicts, based on the result of comparing the first traveling path with the second traveling path, a third traveling path along which the conveyance vehicle travels, and

the control unit generates the control information based on the first traveling path and the third traveling path.

### (Supplementary Note 4)

The conveyance system according to Supplementary Note 2 or 3, wherein the control unit generates, when the control unit determines that an amount of deviation of the conveyance vehicle from the first traveling path has become equal to or larger than a predetermined value based on the positional information of the conveyance vehicle, the control information, and transmits the control information to the conveyance vehicle via the communication unit.

### (Supplementary Note 5)

The conveyance system according to Supplementary Note 2 or 3, wherein the control unit generates, when the control unit determines that the conveyance vehicle is traveling in a specific section based on the positional information of the conveyance vehicle, the control information, and transmits the control information to the conveyance vehicle via the communication unit.

### (Supplementary Note 6)

The conveyance system according to any one of Supplementary Notes 1 to 5, wherein

the conveyance vehicle comprises:
a first conveyance vehicle; and
a second conveyance vehicle configured to convey the object in cooperation with the first conveyance vehicle.

### (Supplementary Note 7)

The conveyance system according to Supplementary Note 6, wherein the control unit transmits the control information to the first conveyance vehicle via the communication unit.

### (Supplementary Note 8)

A control apparatus comprising:

a communication unit configured to be able to communicate with a conveyance vehicle that conveys an object based on a first traveling path; and

a control unit configured to control the conveyance vehicle via the communication unit, wherein

the communication unit receives information regarding the position of the conveyance vehicle from a sensor via a network,

the control unit determines a second traveling path based on the information regarding the position of the conveyance vehicle, and

the control unit corrects a traveling trajectory of the conveyance vehicle based on the first traveling path and the second traveling path.

### (Supplementary Note 9)

The control apparatus according to Supplementary Note 8, wherein

the control unit generates positional information indicating the position of the conveyance vehicle based on the information regarding the position of the conveyance vehicle,

the control unit determines the second traveling path based on the positional information of the conveyance vehicle,

the control unit compares the first traveling path with the second traveling path,

the control unit generates control information for correcting a traveling trajectory of the conveyance vehicle based on the result of comparing the first traveling path with the second traveling path, and

the control unit transmits the control information to the conveyance vehicle via the communication unit.

### (Supplementary Note 10)

The control apparatus according to Supplementary Note 9, wherein

the control unit predicts, based on the result of comparing the first traveling path with the second traveling path, a third traveling path along which the conveyance vehicle travels, and

the control unit generates the control information based on the first traveling path and the third traveling path.

### (Supplementary Note 11)

The control apparatus according to Supplementary Note 9 or 10, wherein the control unit generates, when the control unit determines that an amount of deviation of the conveyance vehicle from the first traveling path has become equal to or larger than a predetermined value based on the positional information of the conveyance vehicle, the control information, and transmits the control information to the conveyance vehicle via the communication unit.

### (Supplementary Note 12)

The control apparatus according to Supplementary Note 9 or 10, wherein the control unit generates, when the control unit determines that the conveyance vehicle is traveling in a specific section based on the positional information of the conveyance vehicle, the control information, and transmits the control information to the conveyance vehicle via the communication unit.

### (Supplementary Note 13)

The control apparatus according to any one of Supplementary Notes 9 to 12, wherein

the conveyance vehicle comprises:
a first conveyance vehicle; and
a second conveyance vehicle configured to convey the object in cooperation with the first conveyance vehicle, and

the control unit transmits the control information to the first conveyance vehicle via the communication unit.

### (Supplementary Note 14)

A control method executed by a control apparatus, the control method comprising:

a receiving step of receiving, from a sensor, information regarding a position of a conveyance vehicle that conveys an object based on a first traveling path via a network; and

a control step of determining a second traveling path based on the information regarding the position of the conveyance vehicle, and correcting a traveling trajectory of the conveyance vehicle based on the first traveling path and the second traveling path.

### (Supplementary Note 15)

The control method according to Supplementary Note 14, wherein

in the control step,

positional information indicating the position of the conveyance vehicle is generated based on the information regarding the position of the conveyance vehicle,

the second traveling path is determined based on the positional information of the conveyance vehicle,

the first traveling path is compared with the second traveling path,

control information for correcting a traveling trajectory of the conveyance vehicle is generated based on the result of comparing the first traveling path with the second traveling path, and

the control information is transmitted to the conveyance vehicle.

### (Supplementary Note 16)

The control method according to Supplementary Note 15, wherein

in the control step,

a third traveling path along which the conveyance vehicle travels is predicted based on the result of comparing the first traveling path with the second traveling path, and

the control information is generated based on the first traveling path and the third traveling path.

### (Supplementary Note 17)

The control method according to Supplementary Note 15 or 16, wherein

in the control step,

when it is determined that an amount of deviation of the conveyance vehicle from the first traveling path has become equal to or larger than a predetermined value based on the positional information of the conveyance vehicle, the control information is generated, and the control information is transmitted to the conveyance vehicle.

### (Supplementary Note 18)

The control method according to Supplementary Note 15 or 16, wherein

in the control step,

when it is determined that the conveyance vehicle is traveling in a specific section based on the positional information of the conveyance vehicle, the control information is generated and the control information is transmitted to the conveyance vehicle.

### (Supplementary Note 19)

The control method according to any one of Supplementary Notes 15 to 18, wherein

the conveyance vehicle comprises:
a first conveyance vehicle; and
a second conveyance vehicle configured to convey the object in cooperation with the first conveyance vehicle.

### REFERENCE SIGNS LIST

1, 2, 3 CONVEYANCE SYSTEM
10 CONVEYANCE VEHICLE
10A FIRST CONVEYANCE VEHICLE
10B SECOND CONVEYANCE VEHICLE
20 SENSOR
30 CONTROL APPARATUS
31 CONTROL UNIT
311 POSITIONAL INFORMATION GENERATION UNIT
312 EVALUATION UNIT
313 PREDICTION UNIT
314 CONTROL INFORMATION GENERATION UNIT
32 COMMUNICATION UNIT
90 COMPUTER
91 PROCESSOR
92 MEMORY
93 STORAGE
94 INPUT/OUTPUT INTERFACE
941 DISPLAY DEVICE
942 INPUT DEVICE
943 SOUND OUTPUT DEVICE
95 COMMUNICATION INTERFACE
X OBJECT
R1 FIRST TRAVELING PATH
R2 SECOND TRAVELING PATH
R3 THIRD TRAVELING PATH

What is claimed is:

1. A conveyance system comprising:
a conveyance vehicle configured to convey an object based on a first traveling path;
a sensor configured to transmit information regarding a position of the conveyance vehicle via a network;
at least one transceiver configured to be able to communicate with the conveyance vehicle and the sensor;
at least one memory storing instructions; and
at least one processor configured to execute the instructions to;
determine a second traveling path based on the information regarding the position of the conveyance vehicle, and
correct a traveling trajectory of the conveyance vehicle based on the first traveling path and the second traveling path.

2. The conveyance system according to claim 1, wherein
the at least one processor is further configured to execute the instructions to
generate positional information indicating the position of the conveyance vehicle based on the information regarding the position of the conveyance vehicle,
determine the second traveling path based on the positional information of the conveyance vehicle,
compare the first traveling path with the second traveling path,
generate control information for correcting a traveling trajectory of the conveyance vehicle based on the result of comparing the first traveling path with the second traveling path, and
transmit the control information to the conveyance vehicle via the at least one transceiver.

3. The conveyance system according to claim 2, wherein
the at least one processor is further configured to execute the instructions to
predict, based on the result of comparing the first traveling path with the second traveling path, a third traveling path along which the conveyance vehicle travels, and
generate the control information based on the first traveling path and the third traveling path.

4. The conveyance system according to claim 2, wherein the at least one processor is further configured to execute the instructions to generate, when it is determined that an amount of deviation of the conveyance vehicle from the first traveling path has become equal to or larger than a predetermined value based on the positional information of the conveyance vehicle, the control information, and transmit the control information to the conveyance vehicle via the at least one transceiver.

5. The conveyance system according to claim 2, wherein the at least one processor is further configured to execute the instructions to generate, when it is determined that the conveyance vehicle is traveling in a specific section based on the positional information of the conveyance vehicle, the control information, and transmit the control information to the conveyance vehicle via the at least one transceiver.

6. The conveyance system according to claim 2, wherein
the conveyance vehicle comprises:
a first conveyance vehicle; and
a second conveyance vehicle configured to convey the object in cooperation with the first conveyance vehicle.

7. The conveyance system according to claim 6, wherein the at least one processor is further configured to execute the instructions to transmit the control information to the first conveyance vehicle via the at least one transceiver.

8. A control apparatus comprising:
at least one transceiver configured to be able to communicate with a conveyance vehicle that conveys an object based on a first traveling path;
at least one memory storing instructions; and
at least one processor configured to execute the instructions to;
receive information regarding a position of the conveyance vehicle from a sensor via a network,
determine a second traveling path based on the information regarding the position of the conveyance vehicle, and
correct a traveling trajectory of the conveyance vehicle based on the first traveling path and the second traveling path.

9. The control apparatus according to claim 8, wherein
the at least one processor is further configured to execute the instructions to
generate positional information indicating the position of the conveyance vehicle based on the information regarding the position of the conveyance vehicle,
determine the second traveling path based on the positional information of the conveyance vehicle,
compare the first traveling path with the second traveling path,
generate control information for correcting a traveling trajectory of the conveyance vehicle based on the result of comparing the first traveling path with the second traveling path, and
transmit the control information to the conveyance vehicle via the at least one transceiver.

10. The control apparatus according to claim 9, wherein
the at least one processor is further configured to execute the instructions to
predict, based on the result of comparing the first traveling path with the second traveling path, a third traveling path along which the conveyance vehicle travels, and
generate the control information based on the first traveling path and the third traveling path.

11. The control apparatus according to claim 9, wherein the at least one processor is further configured to execute the instructions to generate, when it is determined that an amount of deviation of the conveyance vehicle from the first traveling path has become equal to or larger than a predetermined value based on the positional information of the conveyance vehicle, the control information, and transmit the control information to the conveyance vehicle via the at least one transceiver.

12. The control apparatus according to claim 9, wherein the at least one processor is further configured to execute the instructions to generate, when it is determined that the conveyance vehicle is traveling in a specific section based on the positional information of the conveyance vehicle, the control information, and transmit the control information to the conveyance vehicle via the at least one transceiver.

13. The control apparatus according to claim 9, wherein
the conveyance vehicle comprises:
a first conveyance vehicle; and
a second conveyance vehicle configured to convey the object in cooperation with the first conveyance vehicle, and
the at least one processor is further configured to execute the instructions to transmit the control information to the first conveyance vehicle via the at least one transceiver.

14. A control method executed by a control apparatus, the control method comprising:
a receiving step of receiving, from a sensor, information regarding a position of a conveyance vehicle that conveys an object based on a first traveling path via a network; and
a control step of determining a second traveling path based on the information regarding the position of the conveyance vehicle, and correcting a traveling trajectory of the conveyance vehicle based on the first traveling path and the second traveling path.

15. The control method according to claim 14, wherein
in the control step,
positional information indicating the position of the conveyance vehicle is generated based on the information regarding the position of the conveyance vehicle,
the second traveling path is determined based on the positional information of the conveyance vehicle,
the first traveling path is compared with the second traveling path,
control information for correcting a traveling trajectory of the conveyance vehicle is generated based on the result of comparing the first traveling path with the second traveling path, and
the control information is transmitted to the conveyance vehicle.

16. The control method according to claim 15, wherein
in the control step,
a third traveling path along which the conveyance vehicle travels is predicted based on the result of comparing the first traveling path with the second traveling path, and
the control information is generated based on the first traveling path and the third traveling path.

17. The control method according to claim 15, wherein
in the control step,
when it is determined that an amount of deviation of the conveyance vehicle from the first traveling path has become equal to or larger than a predetermined value based on the positional information of the conveyance vehicle, the control information is generated, and the control information is transmitted to the conveyance vehicle.

18. The control method according to claim 15, wherein
in the control step,
when it is determined that the conveyance vehicle is traveling in a specific section based on the positional information of the conveyance vehicle, the control information is generated and the control information is transmitted to the conveyance vehicle.

19. The control method according to claim 15, wherein
the conveyance vehicle comprises:
a first conveyance vehicle; and
a second conveyance vehicle configured to convey the object in cooperation with the first conveyance vehicle.
